(19) United States
(12) Patent Application Publication
(10) Pub. No.: US 2006/0285320 A1
(43) Pub. Date: Dec. 21, 2006

(54) Portable power supply with audio device

(76) Inventors: Lyle Geyer, Leoti, KS (US); Charles Lapetina, Denver, CO (US)

Correspondence Address: ERICKSON & KLEYPAS, L.L.C., 800 W. 47TH STREET, SUITE 401, KANSAS CITY, MO, 64112, US

(21) Appl. No.: 11/451,830

(22) Filed: Jun. 13, 2006

Related U.S. Application Data
(60) Provisional application No. 60/691,146, filed on Jun. 16, 2005.

(51) Int. Cl. F21L 4/00

(52) U.S. Cl. 362/157

(57) ABSTRACT

A portable power supply device, such as an electrical generator or an air compressor, provided with a portable audio source such as an AM/FM radio, CD player, two-way communication radio, or device using random access memory for storage of audio data such as MP3 players. The device includes vibration-dampening elements to isolate the audio source from vibration generated by the moving elements of the power supply.

### BACKGROUND OF THE INVENTION

The present invention relates generally to portable power supplies such as portable electric generators and portable air compressors and, more particularly, to portable power supplies providing integrated audio sources such as AM/FM radios, CD players, and two-way radios.

Portable power supplies such as electrical generators and air compressors are typically used at home or on a construction job site to power tools used in construction such as saws and nail guns. Because they are designed for portability, these power supplies are readily moved from one location to another and are typically placed in proximity to persons using the associated tools or other powered devices. Whether at home or on the job site, it is not uncommon for individuals to also bring AM/FM radios, CD players or other audio devices to the work site in order to provide music or other diversion to pass the time more enjoyably. Because an individual will often carry tools while moving a compressor, for example, from one location at a work site to another, he or she must often return to the original location to retrieve the audio player. Alternatively, the individual may simply increase the volume setting on the audio player to broadcast sound to a larger working area. Unfortunately, this may contribute to the overall noise level of a job site and may annoy or distract other workers.

It would be advantageous, therefore, for a portable power supply to be provided with one or more audio devices integral to the power supply body or housing so that the source of audio could readily remain in proximity to the user as the power supply is moved from one location to another.

### BRIEF SUMMARY OF THE INVENTION

A portable power supply such as an electrical generator or air compressor may include a support surface, such as a housing panel, adapted to receive and hold in place an integrated audio source such as an AM/FM radio, CD player, two-way communication radio, or device using random access memory for storage of audio data such as an MP3 player. A primary vibration dampening element such as a gasket is interposed between the cover or case of the audio source and the housing of the power supply in order to dampen vibrations caused by moving elements of the power supply such as an engine, motor, pump or associated moving parts. In addition, the vibrations caused by the power supply may be at least partially isolated from the housing by interposing secondary vibration dampening elements between the housing and the moving elements. Additional vibration dampening elements, such as pliable, rubber-like feet attached to the power supply, aid in dampening vibrations generated by the engine, motor or pump and therefore reduce the vibrations transmitted to the audio source. Through the use of dampening elements to isolate the audio source from the housing, and the moving elements from the housing, audio sources sensitive to vibration, such as radios and CD players, may be used even in association with power supplies known to generate significant vibration.

Other advantages of the invention will become apparent from the following description taken in connection with the accompanying drawings, wherein is set forth by way of illustration and example an embodiment of the present invention.

### BRIEF DESCRIPTION OF THE SEVERAL VIEWS OF THE DRAWING

FIG. 1 is an exploded view of a portable air compressor provided with an integral radio.

FIG. 2 is a detailed cross sectional view of a vibration dampening connector.

FIG. 3 is an exploded view of a radio subassembly.

FIG. 4 is an exploded view of a portable air compressor provided with an integral CD player.

FIG. 5 is an exploded view of a portable air compressor provided with an alternative integral radio.

### DETAILED DESCRIPTION OF THE INVENTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

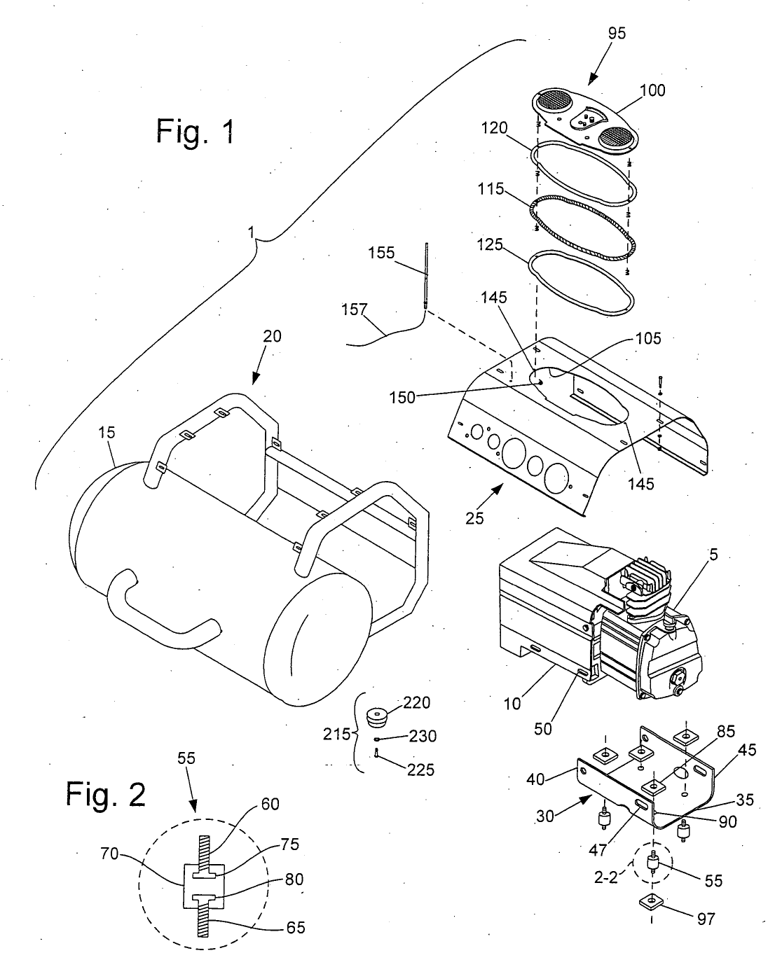

Referring now to FIG. 1 of the drawings, there is shown a portable power supply, in this case an air compressor, indicated by the reference numeral 1. Only selected major elements of the compressor 1 are shown and described herein as it should be appreciated that air compressors and their function, structure and assembly, absent the improvements of the present invention, are well known in the prior art. As illustrated, an air compressor comprises an electric motor 5 that powers a pump 10 for delivering air to a compressed air tank 15. A frame 20, such as a frame of tubular metal, is attached (typically welded) to the tank 15 and provides a structure for attaching power supply components such as the pump 10. A housing 25, such as a metal panel, is bolted or otherwise attached to the frame 20 and provides a structure for attaching the audio supply.

As illustrated, the pump 10 and motor 5 are bolted to a bracket 30 that is further attached to the frame 20 or housing 25. The bracket 30 may comprise a U-shaped piece of rigid material such as steel having a horizontal base 35 and upwardly extending arms 40 and 45. After positioning the pump 10 between the bracket arms 40 and 45, the pump 10 is attached to the bracket 30 by screwing bolts or machine screws through holes 47 in the bracket arms 40 and 45 into tapped holes 50 in the sides of the pump 10.

The bracket 30 is attached to the frame 20 or housing 25 using a vibration dampening connector 55 (see detailed, cross sectional view in FIG. 2) comprising a pair of threaded rods 60 and 65 projecting in opposing directions along a generally common axis, the ends proximate to one another being encased within a pliable rubber or rubber-like cushion 70. The encased ends of the rods 60 and 65 are typically capped with flanges 75 and 80 to retain the ends within the cushion 70. The encased ends of the rods 60 and 65 are separated from one another by a portion of the cushion 70 so that vibrations cannot readily be transmitted from one rod to another. The rods 60 and 65 may comprise appropriately sized bolts or machine screws.

In attaching the bracket 30 to the frame 20, the upper rod 60 is passed through a hole 90 in the lower surface of the bracket base 35 and threaded through an upper nut 85 proximate to the upper surface of the bracket base 35. The nut 85 is tightened until the cushion 70 abuts the lower surface of the base 35. The lower rod 65 is passed through a hole (not shown) in the frame 20 and then similarly secured in place through engagement with a lower nut 97. The nut 97 is tightened until the cushion 70 abuts the surface of the frame 20.

It should be appreciated that certain embodiments of a pump 10 could be directly attached to the frame 20 without the need for a bracket 30, in which case the vibration dampening connectors 55 would attach directly to the pump 10 or pump motor 5 housing, the innovation being the provision of vibration dampening means between the pump and the other structural elements of the compressor 1.

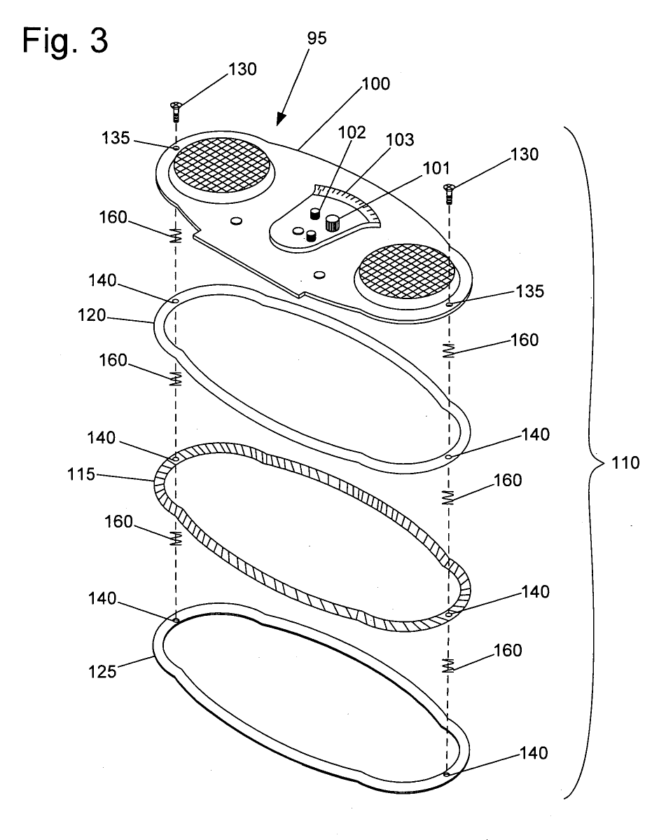

The audio device, such as a radio 95, typically includes a cover plate 100 that is secured to the housing 25 (see FIGS. 1 and 3). The cover plate 100 typically houses tuning 101 and volume 102 adjustment knobs as well as a dial 103 for indicating the selected radio station. Radio components underlying the cover plate 100 are received into an aperture 105 in the housing 25. In order to isolate the radio 95 from vibrations transmitted through the housing 25, the cover 100 is separated from the housing surface by a vibration-absorbing gasket assembly 110. The gasket assembly 110 comprises a pliable, vibration-absorbing center gasket 115 sandwiched between two similarly sized and shaped upper and lower rigid gaskets 120 and 125. The pliable center gasket 115 comprises compressible, resilient, rubber or rubber-like material such as neoprene. The rigid gaskets 120 and 125 are preferably formed of plastic. The gaskets 120 through 125 are shaped to generally follow the contours of the housing aperture 105 and are slightly larger than the aperture 105. The cover 100 is secured to the housing 25 by passing bolts or screws 130 through holes 135 in the cover 100 and then through corresponding holes 140 in underlying gasket assembly 110 elements. The bolts 130 are then passed through corresponding holes 145 in the housing 25 and secured through engagement with nuts 150. An antenna 155 (preferably comprising flexible materials) is attached to the housing 25 and connected via wire 157 to the radio 95.

To further enhance the vibration and shock absorbing qualities of the gasket assembly 110, springs 160 may be positioned between each of the cover 100, upper rigid gasket 120, pliable center gasket 115, and lower rigid gasket 125 so that the bolts 130 pass through the center of the springs 160 as the radio 95 and gasket assembly 110 are secured to the housing 25.

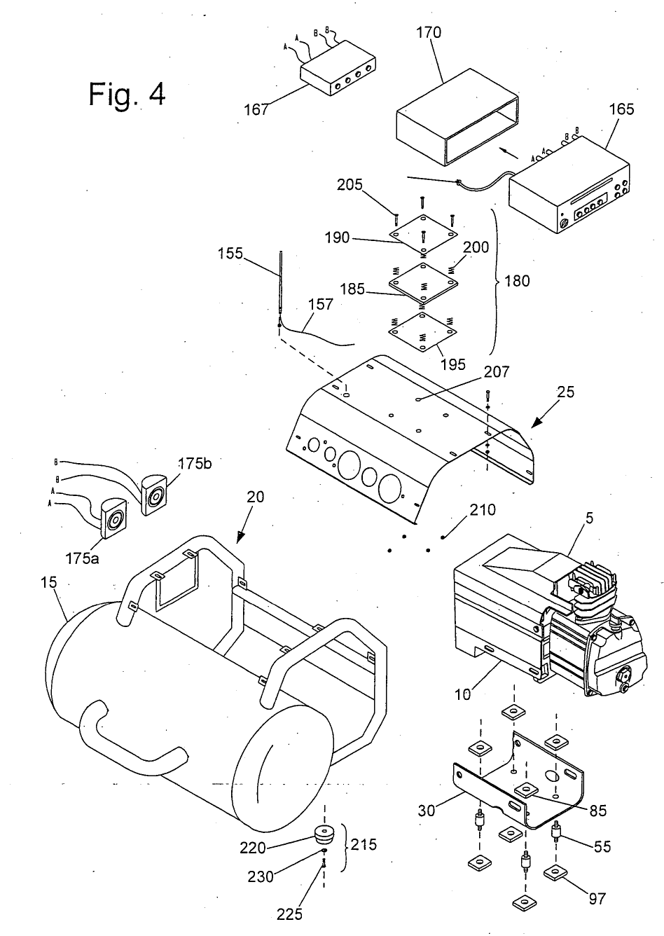

In an alternative embodiment in which a compact disc (CD) player 165 is integrated with the compressor 1 (see FIG. 4), the player 165 is installed within a case 170 that is attached to the upper surface of the housing 25 and may include an internal or external amplifier 167. If not integral to the player 165 or case 170, speakers 175 are attached to the frame 20 or housing 25 and connected via wire leads A and B to corresponding leads or terminals at the amplifier 167. A vibration absorption pad assembly 180 (typically shaped to accommodate the shape of the case 170) is placed between the case 170 and the housing 25 to reduce transmission of vibrations from the housing 25 to the case 170 and player 165. Similar to the gasket assembly 110, the pad assembly 180 comprises a pliable rubber or rubber-like pad 185 (such as neoprene) sandwiched between rigid plastic plates 190 and 195. Springs 200 are located between each pad assembly layer 185-195 to provide additional vibration and shock absorbance. The case 170 is typically attached to the pad assembly 180, and the pad assembly 180 to the housing 25, through use of bolts 205 threaded through each of the above 180 elements and then through holes 207 in the housing 25 to engage underlying nuts 210.

Further vibration dampening may be achieved by providing cushioned feet 215 (see FIGS. 1, 4 and 5) that support the compressor 1 on a surface such as a floor or the ground. The feet 215 comprise cushions 220 of vibration-absorbing material such as rubber, foam rubber such as neoprene, or other pliable materials in order to partially absorb vibrations that would otherwise be transmitted, and perhaps exacerbated, through contact with a hard ground surface such as a concrete floor or slab. The feet 215 may be attached to the frame 20 or to the compressor tank 15 by threading a bolt 225 through a washer 230 and then through the cushion 220 to threadably engage the bolt 225 with a threaded bore (not shown) in, or in a fitting attached to, the frame 20 or tank 15.

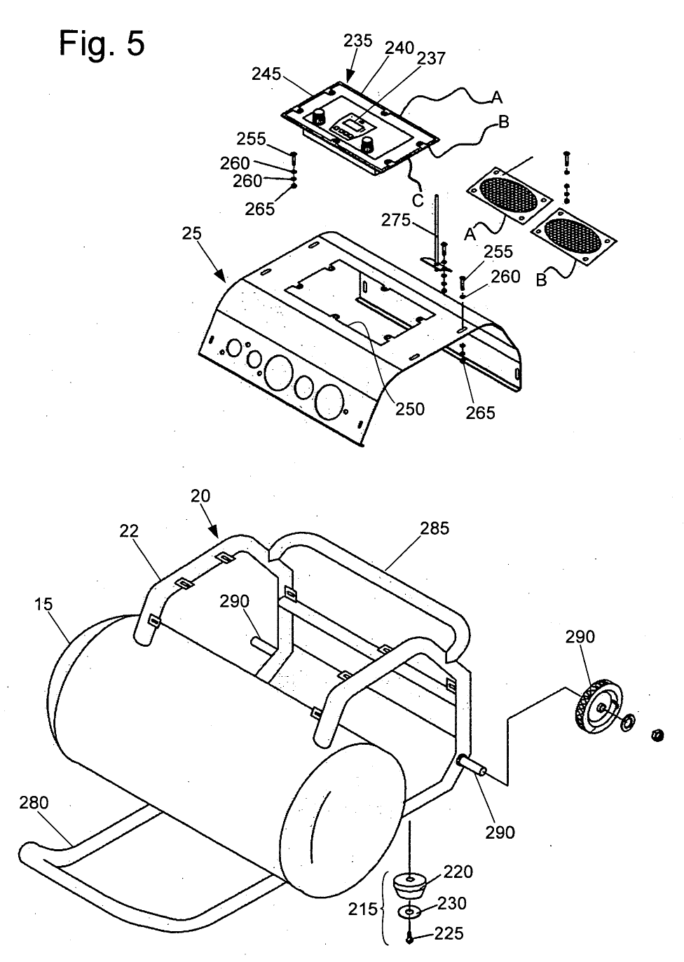

In yet a further embodiment of an audio air compressor 1, a radio 235 with a digital station display 237 is integrated with the compressor through attachment to the compressor housing 25. It has been observed that radios with digital displays, versus mechanical dials, are somewhat less prone to deleterious effects of pump vibration such as loss of tuning. Therefore, a vibration-absorbing gasket may be omitted particularly if cushioned feet 215 are utilized to support the compressor 1. In the embodiment illustrated in FIG. 5, the radio 235 includes a cover plate 240 having a peripheral flange 245 that abuts the portion of the housing 25 surrounding the housing aperture 250. Portions of the radio 235 (e.g. radio circuitry) attached to the lower portion of the cover plate 240 fit into the main housing aperture 250. The cover plate 240 is secured to the housing 25 using bolts 255, washers 260 and nuts 265. Speakers 270a and 270b may be secured to the housing 25 and attached via wire leads A and B to corresponding wire leads or terminals on the radio 235. An antenna 275 may also be attached to the housing to improve reception and is attached via wire lead C to the radio.

As shown in FIG. 5, a forward extension of the lower part of the frame 20 may be formed into a forward handle 280. An additional rearward handle 285 may be welded or otherwise attached across the upper, rearward portions of transverse frame elements 22. Posts projecting outwardly from the transverse frame elements 22 form axles 290 to support wheels 295, thereby enabling the compressor 1 to be rolled upon the wheels 295 after lifting the forward handle 280.

It should be appreciated that the present invention may be practiced with power supply devices other than air compressors, such as electrical generators, and that various audio devices may be employed in addition to radios and CD players as audio generating devices advance in the arts. In particular, it is foreseen that an audio device using random access storage media, such as an MP3 player, may be used in accordance with the present invention. It is to be understood that while certain forms of this invention have been illustrated and described, it is not limited thereto except insofar as such limitations are included in the following claims and allowable equivalents thereof.

1. A portable power supply with integral audio, comprising:
a power supply, including a motor and a frame supporting said motor,
an audio device attached to said frame, and
means for dampening vibration transmitted from said frame to said audio device.

2. The portable power supply of claim 1, wherein said power supply comprises an electric generator.

3. The portable power supply of claim 1, wherein said power supply comprises an air compressor.

4. The portable power supply of claim 1, wherein said audio device comprises a radio receiver.

5. The portable power supply of claim 1, wherein said audio device comprises a CD player.

6. The portable power supply of claim 1, wherein said audio device comprises a device utilizing random access memory for storage of audio data.

7. The portable power supply of claim 1, wherein said means for dampening vibration comprises one or more cushioned feet for supporting said frame upon a surface.

8. The portable power supply of claim 1, further including a housing attached to said frame wherein said audio device is secured upon said frame via attachment to said housing.

9. The portable power supply of claim 8, wherein said means for dampening vibration comprises a vibration-absorbing gasket assembly interposed between said audio device and said housing.

10. The portable power supply of claim 9, wherein said gasket assembly comprises a flexible, vibration-absorbing gasket interposed between said audio device and said housing.

11. The portable power supply of claim 10, wherein said gasket comprises neoprene.

12. The portable power supply of claim 9, wherein said gasket assembly comprises a flexible, compressible center gasket sandwiched between a relatively rigid upper gasket and a relatively rigid lower gasket.

13. The portable power supply of claim 12, wherein said gasket assembly further comprises springs positioned between said gaskets to enhance the vibration-absorbing properties of the gasket assembly.

14. An air compressor having an integral audio device, comprising:
an air compressor including a motor,
a frame supporting said motor,
a housing attached to said frame,
an audio device attached to said housing, and
means for dampening vibration transmitted from said motor to said audio device.

15. The air compressor of claim 14, wherein said means for dampening vibration comprises a gasket assembly interposed between said audio device and said housing.

16. The air compressor of claim 15, wherein said gasket assembly comprises a flexible, compressible center gasket sandwiched between a relatively rigid upper gasket and a relatively rigid lower gasket.

17. The air compressor of claim 14, wherein said means for dampening vibration comprises one or more vibration-absorbing cushioned feet attached to a lower portion of said frame for supporting said air compressor upon a surface.

18. An audio device integral with a portable power supply, the apparatus comprising:
a power supply including a motor, a frame supporting said motor and a housing attached to said frame, said frame including an aperture for receiving an audio device, said audio device including a cover plate wherein at least a portion of the perimeter of said cover plate bears upon a portion of said housing proximate to said aperture,
a first means for dampening vibration transmitted from said housing to said audio device, and
a second means for dampening vibration transmitted from said housing to said audio device, whereby vibrations induced by said motor and transmitted from said housing to said audio device are at least partially dampened.

19. The apparatus of claim 18, wherein said first means for dampening vibration comprises a gasket assembly interposed between said cover plate and said portion of said housing.

20. The apparatus of claim 18, wherein said second means for dampening vibration comprises one or more vibration-absorbing cushioned feet attached to a lower portion of said frame for supporting said device upon a surface.
